(19) United States
(12) Patent Application Publication
(10) Pub. No.: US 2016/0071114 A1
(43) Pub. Date: Mar. 10, 2016

(54) REPORTING MANAGEMENT SYSTEMS AND TECHNIQUES FOR REGULATORY COMPLIANCE

(71) Applicants: Marc W. Gerdisch, Zionsville, IN (US); Robert Gerdisch, Zionsville, IN (US)

(72) Inventors: Marc W. Gerdisch, Zionsville, IN (US); Robert Gerdisch, Zionsville, IN (US)

(21) Appl. No.: 14/846,722

(22) Filed: Sep. 4, 2015

Related U.S. Application Data
(60) Provisional application No. 62/047,492, filed on Sep. 8, 2014.
(60) Provisional application No. 62/139,271, filed on Mar. 27, 2015.

(51) Int. Cl. G06Q 30/00

(52) U.S. Cl. CPC G06Q 30/018; G06Q 50/22

(57) ABSTRACT

Disclosed herein are systems and techniques for reporting management for regulatory compliance. For example, an event management computing system may receive event data from a manufacturer computing system. In response to receipt of the event data, the event management computing system may provide an electronic code to a care provider computing system associated with an invited care provider. At the event, the care provider computing system may provide the electronic code to the manufacturer computing system to demonstrate attendance at the event. The event management computing system may receive an amount spent on the care provider at the event from the manufacturer computing system, and may transmit an identifier of the care provider, and an indicator of the amount spent on the care provider at the event, to the regulator computing system.

### CROSS REFERENCE TO RELATED APPLICATIONS

The present application is a continuation of U.S. Provisional Patent Application No. 62/047,492, filed Sep. 8, 2014, entitled “REPORTING MANAGEMENT SYSTEMS AND TECHNIQUES FOR REGULATORY COMPLIANCE,” and to U.S. Provisional Patent Application No. 62/139,271, filed Mar. 27, 2015, entitled “REPORTING MANAGEMENT SYSTEMS AND TECHNIQUES FOR REGULATORY COMPLIANCE,” the entire disclosures of which are hereby incorporated by reference.

### TECHNICAL FIELD

The present disclosure relates generally to the field of reporting management systems, and more particularly, to reporting management systems and techniques for regulatory compliance.

### BACKGROUND

In the United States, the Physician Payments Sunshine Act requires public disclosure of the amount of money that drug and medical device manufacturers spend on certain kinds of marketing and education for care providers (e.g., doctors and hospital administrators) on an annual basis.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the FIGS. of the accompanying drawings.

FIG. 1 is a block diagram of an illustrative computing system configured for reporting management for regulatory compliance, in accordance with various embodiments.

FIG. 2 is a block diagram of an illustrative reporting management system that may be implemented by the computing system of FIG. 1, in accordance with various embodiments.

FIG. 3 is a flow diagram of a method for transmitting event invitations to invitees, in accordance with various embodiments.

FIG. 4 is an illustrative display that may be provided to a manufacturer computing system by an event management computing system upon login to the event management computing system by a manufacturer's representative, in accordance with various embodiments.

FIG. 5 is an illustrative display that may be provided to a manufacturer computing system by an event management computing system in response to an indication by the manufacturer computing system that a new event entry is to be created, in accordance with various embodiments.

FIG. 6 is an illustrative display that may be provided to a manufacturer computing system by an event management computing system to enable the manufacturer computing system to provide a list of invitees for an event, in accordance with various embodiments.

FIG. 7 is a flow diagram of a method for validating an invitee list, in accordance with various embodiments.

FIG. 8 is an illustrative display that may be provided to a manufacturer computing system by an event management computing system when a care provider account does not exist, in accordance with various embodiments.

FIG. 9 is an illustrative display that may be provided to a manufacturer computing system by an event management computing system to prompt the manufacturer computing system to provide an invitation template, in accordance with various embodiments.

FIG. 10 is an illustrative email that may be transmitted to a manufacturer computing system by an event management computing system to demonstrate the invitation that will be sent to the invitees of an event, in accordance with various embodiments.

FIG. 11 is an illustrative invitation email that may be transmitted to a care provider computing system by an event management computing system, in accordance with various embodiments.

FIG. 12 is an illustrative email, including an electronic code, that may be transmitted to a care provider computing system by an event management computing system, in accordance with various embodiments.

FIG. 13 depicts an illustrative data structure for storing event data, in accordance with various embodiments.

FIG. 14 depicts an illustrative data structure for storing invitee data, in accordance with various embodiments.

FIG. 15 is a flow diagram of a method for creating a care provider account, in accordance with various embodiments.

FIG. 16 is a flow diagram of a method for creating an invitation for a new event, in accordance with various embodiments.

FIG. 17 is a flow diagram of a method for providing new event logistic data, in accordance with various embodiments.

FIG. 18 is a flow diagram of a method for receiving and storing an electronic code, in accordance with various embodiments.

FIG. 19 is a flow diagram of a method for displaying an electronic code, in accordance with various embodiments.

FIG. 20 is a flow diagram of a method for validating and storing attendee data, in accordance with various embodiments.

FIG. 21 is a flow diagram of a method for receiving and processing attendee data, in accordance with various embodiments.

FIG. 22 is an illustrative display that may be provided to a manufacturer computing system by an event management computing system to prompt the manufacturer computing system to input amount spent data, in accordance with various embodiments.

FIG. 23 is an illustrative email that may be provided to a care provider computing system by an event management computing system to prompt the care provider computing system to confirm or reject an amount spent at a symposium, in accordance with various embodiments.

FIG. 24 is an illustrative email that may be provided to a care provider computing system by an event management computing system to prompt the care provider computing system to confirm or reject an amount spent on a gift, in accordance with various embodiments.

### DETAILED DESCRIPTION

Disclosed herein are systems and techniques for reporting management for regulatory compliance. In some embodiments, a reporting management system may include a regulator computing system, an event management computing system, a manufacturer computing system, and a care provider computing system. The event management computing system may receive, over a communications network, event data from a manufacturer computing system. The event data may specify an event (hosted by the manufacturer) and include a list of invitees to the event. The invitees may be care providers whose attendance at the event is required to be reported to a governmental authority for compliance with legal regulations. In response to receipt of the event data from the manufacturer computing system, the event management computing system may provide an electronic code, over a communications network, to a care provider computing system (e.g., a smartphone or tablet) associated with a care provider included in the list of invitees. At the event, the care provider computing system may provide the electronic code to the manufacturer computing system (e.g., using code scanning hardware included in the manufacturer computing system) to demonstrate attendance of the care provider at the event. The event management computing system may receive an amount spent on the care provider at the event from the manufacturer computing system, and may transmit an indicator of the amount spent to the care provider computing system for approval or rejection. Upon receipt of an approval of the amount spent from the care provider computing system, the event management computing system may transmit an identifier of the care provider (associated with the care provider computing system), and an indicator of the amount spent on the care provider at the event, to the regulator computing system.

As used herein, an “event” may refer to any occurrence that may be tracked for compliance with a legal, regulatory, or business reporting purpose. For example, some embodiments of the reporting management systems disclosed herein may be used to track gatherings or social events, such as dinners, cocktail hours, field trips, and lectures. Embodiments of the reporting management systems disclosed herein may be used to track consulting/advising arrangements, such as the retention of a care provider as a consultant to a company's board of directors, on an advisory board, or as a speaker. Embodiments of the reporting management systems disclosed herein may be used to track gifts, such as textbooks or other media, medical equipment, software, or other durable goods. Any suitable event that should be tracked for reporting purposes may be tracked using various embodiments of the reporting management systems disclosed herein.

In the following detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

The description uses the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous. As used herein, the phrase “coupled” may mean that two or more elements are in direct physical or electrical contact, or that two or more elements are not in direct contact with each other, but yet still cooperate or interact with each other (e.g., via one or more intermediate elements, which may perform their own transformations or have their own effects). For example, two elements may be coupled to each other when both elements communicate with a common element (e.g., a memory device). As used herein, the term “logic” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable components that provide the described functionality. As used herein, a signal may be “received” by a component if it is generated externally or internally to that component, and acknowledged and/or processed by that component.

Although email is often used as an example format herein for the transmission of data between various components of a reporting management system, this is simply for illustrative purposes, and any messaging format or combination of messaging formats may be used (such as text messages or a proprietary message format unique to the reporting management system and supported by an app or other plug-in on a computing device).

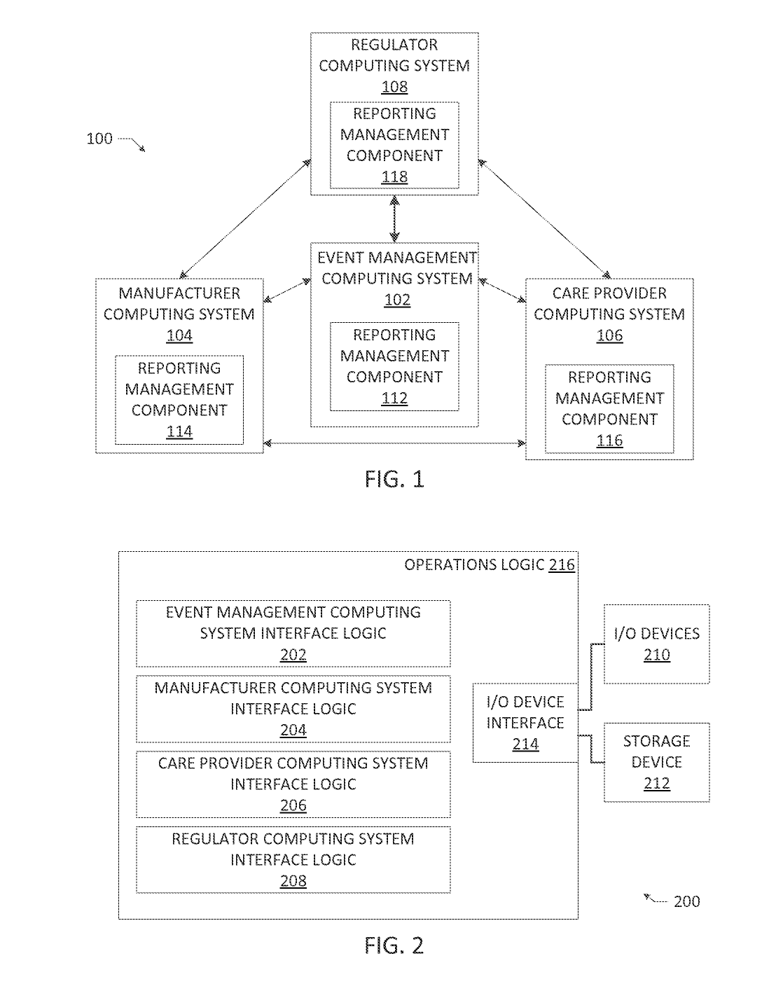

FIG. 1 depicts an illustrative computing system 100 for reporting management for regulatory compliance, in accordance with various embodiments. The computing system 100 may include an event management computing system 102, a manufacturer computing system 104, a care provider computing system 106, and a regulator computing system 108. Each of the event management computing system 102, the manufacturer computing system 104, the care provider computing system 106, and the regulator computing system 108 may include reporting management components (illustrated in FIG. 1 as reporting management components 112, 114, 116, and 118, respectively). Reporting management operations, input/output (I/O) hardware, and logic (e.g., any of the operations and logic discussed below with reference to the reporting management system 200) may be distributed between the reporting management components 112, 114, 116, and 118 of the computing system 100 as suitable. Several examples of the distribution of operations between the components of the computing system 100 are discussed herein, but any other combination of more or less components and distribution of the operations may be used. In some embodiments, the computing system 100 may be configured as the reporting management system 200, discussed below with reference to FIG. 2.

Communication within the computing system 100 may be enabled by any suitable combination of the communication pathways indicated by the double-headed arrows in FIG. 1. The communication pathways may each include wired communication pathways and/or wireless communication pathways, over direct couplings, and/or over personal, local, and/or wide area networks. Each of the event management computing system 102, the manufacturer computing system 104, the care provider computing system 106, and the regulator computing system 108 may include suitable hardware for supporting the communication pathways, such as network interface cards, modems, WiFi devices, Bluetooth devices, near field communication (NFC) devices, and so forth. In some embodiments, the communication pathways may be direct communication pathways between the components as illustrated in FIG. 1. As used herein, references to “direct” communication pathways between two systems of the computing system 100 of FIG. 1 may refer to a communication pathway that does not route through another illustrated component, but that may route through other non-illustrated devices (e.g., routers and/or switches).

Each of the computing systems included in the computing system 100 may include a processing device and a storage device (not shown). The processing device may include one or more processing devices, such as one or more processing cores, application specific integrated circuits (ASICs), electronic circuits, processors (shared, dedicated, or group), combinational logic circuits, and/or other suitable components that may be configured to process electronic data. The storage device may include any suitable memory or mass storage devices (such as solid-state drive, diskette, hard drive, compact disc read only memory (CD-ROM), and so forth). Each of the computing systems included in the computing system 100 may include one or more buses (and bus bridges, if suitable) to communicatively couple the processing device, the storage device, and any other devices included in the respective computing systems. The storage device may include a set of computational logic, which may include one or more copies of computer readable media (e.g., non-transitory computer readable media) having instructions stored therein which, when executed by the processing device of the computing system, may cause the computing system to implement any of the techniques and methods disclosed herein, or any portion thereof. In some embodiments, the computational logic may include any of the logic discussed below with reference to FIG. 2.

The event management computing system 102, the manufacturer computing system 104, the care provider computing system 106, and the regulator computing system 108 may each include peripheral devices, which may communicate via wired or wireless communication pathways, such as cameras, printers, scanners, radio frequency identification (RFID) readers, Quick Response (QR) code readers, credit card swipe devices, or any other peripheral devices. Except for the reporting management teachings of the present disclosure incorporated therein, the event management computing system 102, the manufacturer computing system 104, the care provider computing system 106, and the regulator computing system 108 may include one or more of a broad range of computing devices known in the art.

In particular, each of the event management computing system 102, the manufacturer computing system 104, the care provider computing system 106, and the regulator computing system 108 may include one or more distinct computing devices, such as servers, personal computing devices (such as desktop computers), mobile computing devices (such as laptop computers, tablets, or smartphones). For example, the manufacturer computing system 104 may include a laptop computer used by a manufacturer representative to provide event data to the event management computing system 102, and may also include a mobile computing device with a QR code scanner to scan the QR codes of event attendees and provide identifiers of the attendees to the event management computing system 102. In another example, the event management computing system 102 may include some logic stored locally on a computing device owned by a manufacturer (e.g., a laptop computer located at the manufacturer's office) and may also include logic stored at (and operational from) a location remote from the manufacturer's office (e.g., on a server operated by the manufacturer or by a third-party event management service provider). In another example, the care provider computing system 106 may include a laptop or desktop computer via which the care provider indicates her acceptance of an email invitation to an event, and may also include a smartphone on which an electronic code (provided to the care provider by the event management computing system 102) may be displayed when the care provider arrives at an event sponsored by the manufacturer. The examples are simply illustrative, and any suitable distribution of the hardware and operations disclosed herein among various computing devices included in the event management computing system 102, the manufacturer computing system 104, the care provider computing system 106, and the regulator computing system 108 may be used. Further specific, but not limiting, examples are described below.

The event management computing system 102, the manufacturer computing system 104, the care provider computing system 106, and/or the regulator computing system 108 may include none, one, or more mobile computing devices. A mobile computing device may be a computing device that is configured for carrying along with a user. In some embodiments, a mobile computing device may be a wearable computing device, and may be integrated into a garment, accessory, or other support structure that is configured to be worn on the body of the user (or “wearer”). Examples of suitable support structures for the mobile computing device may include glasses, a headset, a hair accessory (e.g., a headband or barrette), an ear piece, jewelry (e.g., brooch, earrings, or a necklace), a wrist band (e.g., a wristwatch), a neck band (e.g., a tie or scarf), a garment (e.g., a shirt, pants, dress skirt, or jacket), a hat, shoes, a lanyard or name tag, a contact lens, or an implantable support structure, among others. In some embodiments, a mobile computing device may be a computing device configured for carrying in a pocket, backpack, or other carrying case. Particular examples of mobile computing devices include cellular phones, smartphones, other personal mobile communication devices, tablets, electronic book readers, personal digital assistants, laptops, or other such computing devices. Reporting management and other operations performed by a mobile computing device included in any of the event management computing system 102, the manufacturer computing system 104, the care provider computing system 106, and the regulator computing system 108 may be controlled by an app or plug-in on the mobile computing device, for example. In some embodiments, a mobile computing device may access a website or other network-based resource to perform some or all of its reporting management operations, as suitable. Although a mobile computing device may be referred to in the singular, the event management computing system 102 may include two or more distinct devices associated with the user. For example, a mobile computing device may include a wrist-mounted computing device in communication with a smartphone. Processing operations performed by the mobile computing device in this example may be distributed between the wrist-mounted computing device and the smartphone.

The event management computing system 102, the manufacturer computing system 104, the care provider computing system 106, and/or the regulator computing system 108 may include none, one, or more stationary personal computing devices. A stationary personal computing device may be a computing device configured to rest semi-permanently on a surface (e.g., as a server does in a rack or a desktop computer does on a desk). Examples of personal computing devices include desktop computing devices, point-of-sale terminals, terminals located at a security desk in a facility, and large shared computing kiosks. Reporting management and other operations performed by a stationary personal computing device may be controlled by an application or plug-in on the stationary personal computing device, for example. In some embodiments, a stationary personal computing device may access a website or other network-based resource to perform some or all of its reporting management operations, as suitable. In some embodiments, a stationary personal computing device or a remote computing device (discussed below) may have more computing resources (e.g., processing power, memory, and/or communication bandwidth) than a mobile computing device. Thus, in some embodiments, data captured and preliminarily processed by the mobile computing device may be transmitted to a personal computing device and/or to a remote computing device for further processing.

The event management computing system 102, the manufacturer computing system 104, the care provider computing system 106, and/or the regulator computing system 108 may include none, one, or more remote computing devices. A remote computing device may include one or more servers (e.g., arranged in a “cloud” computing configuration) or other computing devices remote from a mobile computing device or a stationary personal computing device. Communication pathways between a remote computing device and any other computing device (e.g., a remote computing device, a mobile computing device, or a stationary personal computing device) may be configured according to any suitable remote wired or wireless communication protocol. In some embodiments, a remote computing device may have more computing resources (e.g., processing power, memory, and/or communication bandwidth) than a mobile computing device or a stationary personal computing device. Thus, in some embodiments, data captured and preliminarily processed by a mobile computing device and/or a stationary personal computing device may be transmitted over to a remote computing device for further processing. For example, in some embodiments, the event management computing system 102 may be implemented principally as a collection of servers (remote computing devices) that are configured to perform suitable reporting management operations as discussed herein. In some embodiments, the regulator computing system 108 may include a collection of servers (remote computing devices) that are configured to receive attendee and amount spent data from the event management computing system 102 and to use this data to assess regulatory compliance.

In some embodiments, a remote computing device (e.g., included in the event management computing system 102) may communicate with a plurality of stationary personal computing devices and/or a plurality of mobile computing devices (e.g., included in the manufacturer computing system 104 and/or the care provider computing system 106). The remote computing device may perform similar processing and storage operations for each mobile or stationary personal computing device included in the manufacturer computing system 104, and similar processing and storage operations for each mobile or stationary personal computing device included in the care provider computing system 106. For example, a remote computing device included in the event management computing system 102 may maintain care provider accounts for different care providers associated with corresponding different mobile or stationary personal computing devices. The remote computing device included in the event management computing system 102 may maintain manufacturer accounts (to store and track, e.g., event-related data) for different manufacturers associated with corresponding different mobile or stationary personal computing devices. A remote computing device included in the regulator computing system 108 may maintain care provider accounts for different care providers associated with corresponding different mobile or stationary personal computing devices, for different manufacturers associated with corresponding different mobile or stationary personal computing devices, and/or for different event management computing systems associated with corresponding different remote, mobile, or stationary personal computing devices. A remote computing device may devote different resources to different ones of a plurality of mobile or personal stationary computing devices in communication with the remote computing device (e.g., different memory partitions or databases for each device). A remote computing device may devote different resources to different ones of a plurality of systems (e.g., manufacturer computing systems configured as discussed herein for the manufacturer computing system 104 and/or care provider computing systems configured as discussed herein for the care provider computing system 106) in communication with the remote computing device (e.g., different memory partitions or databases for each system).

In some embodiments, one or more of the communication pathways between components of the computing system 100 may not be included; for example, in some embodiments, the care provider computing system 106 and/or the manufacturer computing system 104 may not communicate directly with the regulator computing system 108 (but may communicate with the regulator computing system 108 via the event management computing system 102).

FIG. 2 depicts an illustrative reporting management system 200, in accordance with various embodiments. As discussed above with reference to the computing system 100, the reporting management system 200 may be configured to perform any of a number of reporting management operations. For example, one or more components of the reporting management system 200 may receive, over a communications network from one or more components of the reporting management system 200, event data specifying an event (hosted by a manufacturer) and including a list of invitees to the event. The invitees may be care providers whose attendance at the event is required to be reported to a governmental authority for compliance with legal regulations. In response to receipt of the event data, one or more components of the reporting management system 200 may provide an electronic code, over a communications network, to a care provider (e.g., a care provider computing system, such as a smartphone or tablet) associated with a care provider included in the list of invitees. At the event, the care provider (e.g., via the care provider computing system 106) may provide the electronic code to one or more components of the reporting management system 200 (e.g., using code scanning hardware included in the manufacturer computing system) to demonstrate attendance of the care provider at the event. One or more components of the reporting management system 200 may provide or receive an amount spent on the care provider at the event, and may transmit an indicator of the amount spent to the care provider (e.g., to the care provider computing system 106) for approval or rejection. Upon receipt of an approval of the amount spent from the care provider, one or more components of the reporting management system 200 may transmit an identifier of the care provider (associated with the care provider computing system 106), and an indicator of the amount spent on the care provider at the event, to a regulator (e.g., via the regulator computing system 108).

The reporting management system 200 may be implemented by the computing system 100 of FIG. 1, in accordance with various embodiments. For example, the logic and hardware (e.g., I/O hardware) included in the reporting management system 200 may distributed in any suitable manner between the reporting management components 112, 114, 116, and 118 of the event management computing system 102, a manufacturer computing system 104, a care provider computing system 106, and a regulator computing system 108, respectively. The components of the reporting management system 200 may be distributed in any suitable manner among one or more of the reporting management components 112, 114, 116, and 118 of the computing system 100.

Although a number of components are discussed below with reference to FIG. 2, various embodiments may omit components as appropriate for the reporting management operations to be performed. For example, some embodiments of the reporting management system 200 may not be configured for barcode reading (and instead may use another code identification technique, such as QR codes), and thus may not include a barcode reader.

The reporting management system 200 may include input/output (I/O) devices 210. The I/O devices 210 may include any suitable I/O devices suitable for supporting any of the reporting management operations disclosed herein. Different ones of the event management computing system 102, the manufacturer computing system 104, the care provider computing system 106, and the regulator computing system 108 may include different ones of the I/O devices 210. Additionally, two or more of the event management computing system 102, the manufacturer computing system 104, the care provider computing system 106, and the regulator computing system 108 may include certain ones of the I/O devices 210. Although the I/O devices 210 (and other components described herein) may be referred to in the plural, any number of I/O devices may be included in the I/O devices 210 (and similarly, any component may include multiple such components).

In some embodiments, the I/O devices 210 may include an image capture device. The image capture device may include one or more digital cameras, for example, and may use any imaging wavelength (e.g., visible or infrared light). Images captured by an image capture device included in the manufacturer computing system 104 may be used to capture an image of a code presented by the care provider computing system 106 when the care provider associated with the care provider computing system 106 arrives at an event sponsored by the manufacturer associated with the manufacturer computing system 104. For example, an image capture device may capture an image of a QR code, a bar code, an alphanumeric code, another image-based code (e.g., a watermark), or any other suitable visually presented code.

As used herein, the term “camera” may include still image cameras and video cameras. In some embodiments, the image capture device may be configured to stream image data (e.g., images of captured codes) to other devices via a wired or wireless communication pathway. For example, the image capture device may be included in a mobile computing device of the manufacturer computing system 104, and may stream image data wirelessly to a stationary personal computing device of the manufacturer computing system 104 or to a remote computing device of event management computing system 102.

Examples of other I/O devices that may be included in the I/O devices 210 may include a keyboard, a cursor control device such as a mouse, a stylus, a touchpad, a bar code reader, a short-range wireless receiver (e.g., a Bluetooth receiver or NFC receiver), an audio output device (e.g., one or more speakers or other audio transducers that may be, for example, mounted in one or more earphones or earbuds), printers, projectors, additional storage devices, or any other suitable I/O device.

In some embodiments, the I/O devices 210 may include a Quick Response (QR) code reader. A QR code reader may include hardware and supporting logic to enable the detection, identification, and decoding of a visually rendered QR code, as known in the art. In particular, a computing device included in the manufacturer computing system 104 may include a QR code reader for reading QR codes provided by a computing device included in the care provider computing system 106.

In some embodiments, the I/O devices 210 may include a bar code reader. A bar code reader may include hardware and supporting logic to enable the detection, identification, and decoding of a visually rendered barcode, as known in the art. In particular, a computing device included in the manufacturer computing system 104 may include a bar code reader for reading barcodes provided by a computing device included in the care provider computing system 106.

In some embodiments, the I/O devices 210 may include an audio capture device. An audio capture device may include one or more microphones arranged in various configurations and may capture audio data for storage and/or processing. In some embodiments, an electronic code provided to the care provider computing system 106 by the event management computing system 102 may take the form of an encoded audio signal. A computing device included in the manufacturer computing system 104 may include an audio capture device for listening to the encoded audio signal provided by a computing device of the care provider computing system 106, and may further include logic for decoding the encoded audio signal.

In some embodiments, the I/O devices 210 may include a display. The display may include one or more heads-up displays (i.e., displays including a projector arranged in an optical collimator configuration and a combiner to provide data without requiring a user to look away from his or her typical viewpoint), computer monitors, projectors, touchscreen displays, liquid crystal displays (LCDs), light-emitting diode displays, or flat panel displays, for example. In some embodiments, the care provider computing system 106 may include a display on which a code may be provided to the manufacturer computing system 104. In some embodiments, the care provider computing system 106 may include a display on which a user interface may be provided (e.g., by the event management computing system 102) to enable a care provider to create an account with the event management computing system 102, accept or reject an invitation to an event, and/or confirm or reject an amount spent on the care provider at any previously attended event. In some embodiments, the manufacturer computing system 104 may include a display on which a user interface may be provided (e.g., by the event management computing system 102) to enable a manufacturer's representative to create an account with the event management computing system 102, create an event entry with the event management computing system 102, and/or provide data on an amount spent on each attendee at an event sponsored by the manufacturer. In some embodiments, the regulator computing system 108 may include a display on which a user interface may be provided to review amount spent data provided to the regulator computing system 108 by the event management computing system 102. In some embodiments, the event management computing system 102 may include a display on which a user interface may be provided to enable an administrator of the event management computing system 102 to review event-related data and make changes as appropriate.

In some embodiments, the I/O devices 210 may include a communication device. The communication device may include one or more devices that enable wireless and/or wired communication between various devices instantiating the reporting management system 200 and with devices external to the reporting management system 200. The event management computing system 102, the manufacturer computing system 104, the care provider computing system 106, and the regulator computing system 108 may each include one or more devices having a communication device. Various communication devices included in computing devices in various systems of the computing system 100 may include suitable hardware for supporting the communication pathways shown in FIG. 1, such as network interface cards, modems, WiFi devices, Bluetooth devices, NFC devices, and so forth.

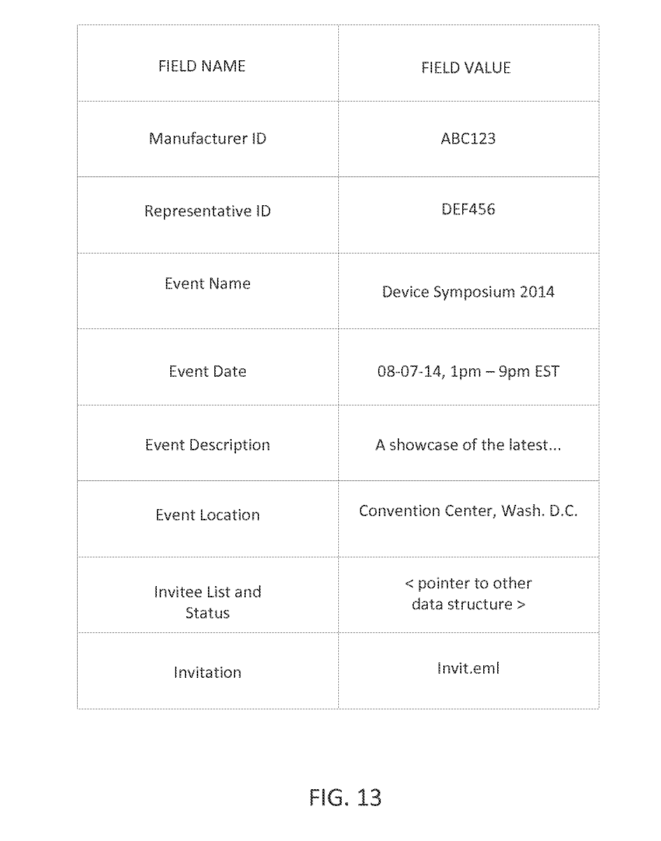

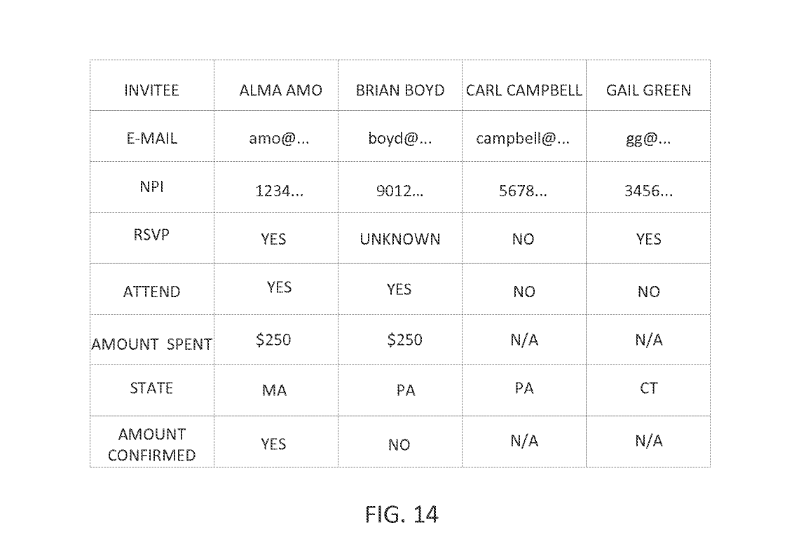

The reporting management system 200 may include a storage device 212. In some embodiments, the storage device 212 may include one or more databases or other data storage structures, which may include memory structures for storing any of the data described herein used for reporting management operations. Examples of data structures that may be included in the storage device 212 are discussed below (e.g., with reference to FIGS. 13 and 14). The storage device 212 may include any volatile or nonvolatile memory device, such as one or more hard drives, solid-state logic, or portable storage media, for example.

The reporting management system 200 may include operations logic 216. The operations logic 216 may include an I/O device interface 214 configured to receive data from the I/O devices 210, and logic components configured to process information provided by the I/O devices 210 or retrieved from the storage device 212 and output the results of the processing to the I/O devices 210 and/or to the storage device 212. Although the components of the operations logic 216 are illustrated separately, the components may be combined or divided as suitable, and each may use one or more of the results generated by others in performing its own processing, as discussed below. Data may be communicated between the components of the operations logic 216 over a physical bus, a long-distance wired communication pathway, a short- or long-distance wireless communication pathway, or any combination of communication pathways. The operations logic 216 may include event management computing system interface logic 202. The logic 202 may be configured to provide data to and/or receive data from the event management computing system 102 in accordance with any of the embodiments discussed herein. Various components of the logic 202 may be included in the manufacturer computing system 104, the care provider computing system 106, and/or the regulator computing system 108, as discussed herein. Data provided to the event management computing system 102 by the logic 202, or data received from the event management computing system 102 by the logic 202, may be stored in the storage device 212 in any appropriate memory structure.

The operations logic 216 may include manufacturer computing system interface logic 204. The logic 204 may be configured to provide data to and/or receive data from the manufacturer computing system 104 in accordance with any of the embodiments discussed herein. Various components of the logic 204 may be included in the event management computing system 102, the care provider computing system 106, and/or the regulator computing system 108, as discussed herein. Data provided to the manufacturer computing system 104 by the logic 204, or data received from the manufacturer computing system 104 by the logic 204, may be stored in the storage device 212 in any appropriate memory structure.

The operations logic 216 may include care provider computing system interface logic 206. The logic 206 may be configured to provide data to and/or receive data from the care provider computing system 106 in accordance with any of the embodiments discussed herein. Various components of the logic 206 may be included in the event management computing system 102, the manufacturer computing system 104, and/or the regulator computing system 108, as discussed herein. Data provided to the care provider computing system 106 by the logic 206, or data received from the care provider computing system 106 by the logic 206, may be stored in the storage device 212 in any appropriate memory structure.

The operations logic 216 may include regulator computing system interface logic 208. The logic 208 may be configured to provide data to and/or receive data from the regulator computing system 108 in accordance with any of the embodiments discussed herein. Various components of the logic 208 may be included in the event management computing system 102, the manufacturer computing system 104, and/or the care provider computing system 106, as discussed herein. Data provided to the regulator computing system 108 by the logic 208, or data received from the regulator computing system 108 by the logic 208, may be stored in the storage device 212 in any appropriate memory structure.

The following paragraphs describe a number of embodiments of reporting management systems and techniques. These embodiments may be combined or distributed among various hardware devices (e.g., the event management computing system 102, the manufacturer computing system 104, the care provider computing system 106, and the regulator computing system 108) in any suitable manner.

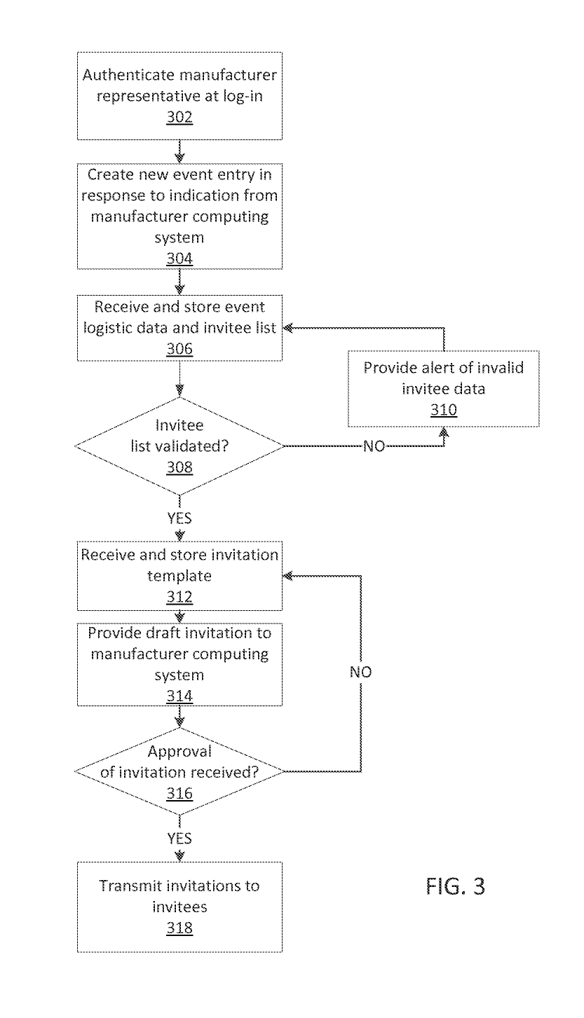

FIG. 3 is a flow diagram of a method for transmitting event invitations to invitees, in accordance with various embodiments. The operations of the method of FIG. 3 (and the other methods described herein), although illustrated as performed in a particular sequence for the sake of illustration, may be performed in parallel as suitable or in any other order. Operations of the method of FIG. 3 (and the other methods described herein) may be described as performed by components of the system 200, as embodied in the computing system 100, for illustrative purposes, but the operations of the method of FIG. 3 (and the other methods described herein) may be performed by any suitably configured computing device or collection of computing devices. Any of the operations of the method of FIG. 3 (and the other methods described herein) may be performed in accordance with any of the embodiments of the systems 100 and 200 described herein. For illustrative purposes, the method of FIG. 3 may be discussed as performed by the event management computing system 102.

The method of FIG. 3 may begin at 302, at which the event management computing system 102 may authenticate a manufacturer representative, operating the manufacturer computing system 104, when the manufacturer representative attempts to log in to a user interface provided by the event management computing system 102. Credentials for authorized manufacturer representatives may be provided by the manufacturer upon subscription to the services provided by the event management computing system 102, and different manufacturer representatives may be authorized for different levels of access to the information and services provided by the event management computing system 102 (e.g., the ability to only view events, the ability to view and edit events created by that representative, the ability to view and edit events created by any representative of the manufacturer, etc.). For example, the event management computing system 102 may store a “tree” or other hierarchical data structure representative of the management hierarchy within the manufacturer company; when a particular representative of the manufacturer creates an event, the individuals who are “superior” to the particular representative in the management hierarchy (and who are recognized as users of the event management computing system 102) may be allowed to view and edit the event (e.g., add invitees to the invitee list). Individuals who are not “superior” may be allowed to view, but not edit, the event, or may not be allowed to view the event at all. In some embodiments, the creating representative may identify particular individuals who are to have view and/or edit access to an event (which may override or take the place of “automatic” hierarchy-based access permissions). In some embodiments, events may be associated with the creating representative (as discussed below), and the representative may be able to access a list of some or all of the care providers who have accounts with the event management computing system 102 for later invitation (as discussed below).

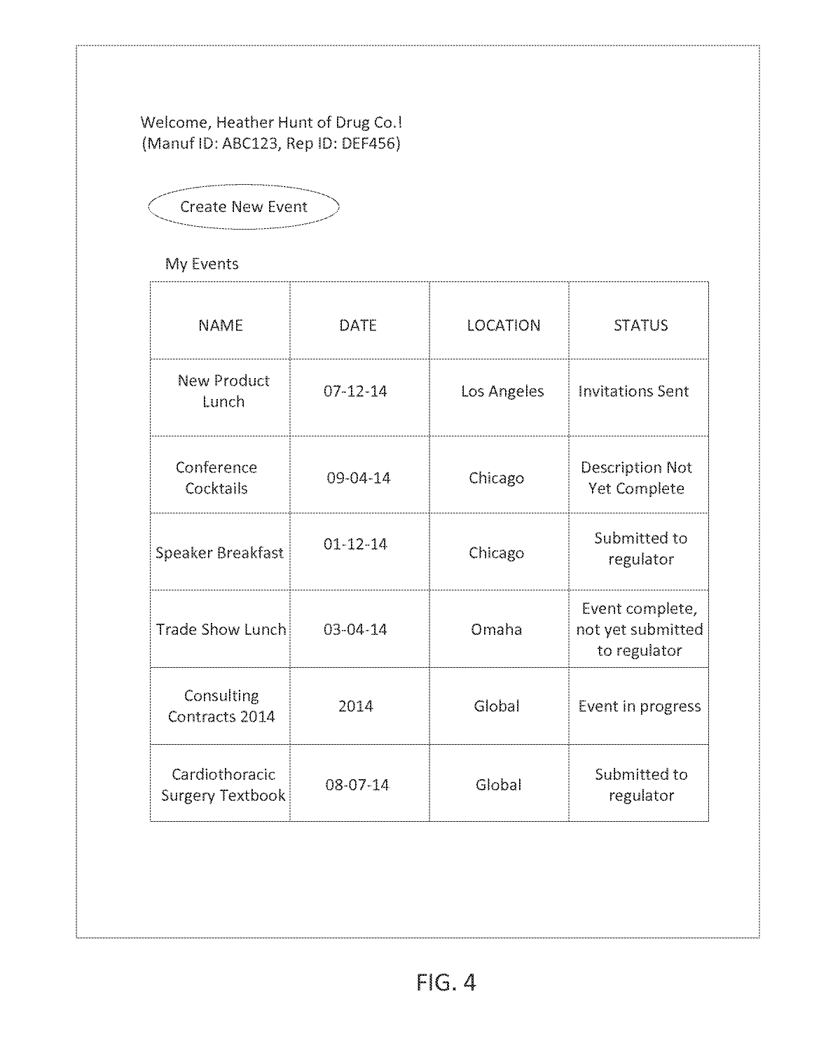

Authentication of the manufacturer representative may use a login name and password, or may use any other authentication or login technique conventionally known. In some embodiments, in response to authentication of the manufacturer representative, the event management computing system 102 may provide the illustrative display of FIG. 4 to a display device included in the manufacturer computing system 104. The display of FIG. 4 may include an identifier of the manufacturer representative (e.g., both the name and an identification number) and an identifier of the manufacturer (e.g., both the name and an identification number). The display of FIG. 4 may include a list of previous events created in the event management computing system 102 (and stored, e.g., in the storage device 212) by the manufacturer representative and/or by other representatives of the same manufacturer. The display of FIG. 4 may also include a status of previously created events, and a selectable option to create a new event in the event management computing system 102.

Returning to FIG. 3, at 304, in response to an indication from the manufacturer computing system 104 to create a new event, the event management computing system 102 may create a new event entry. The creation of a new event entry may include reserving space in a storage device 212 for the storage of data related to the new event.

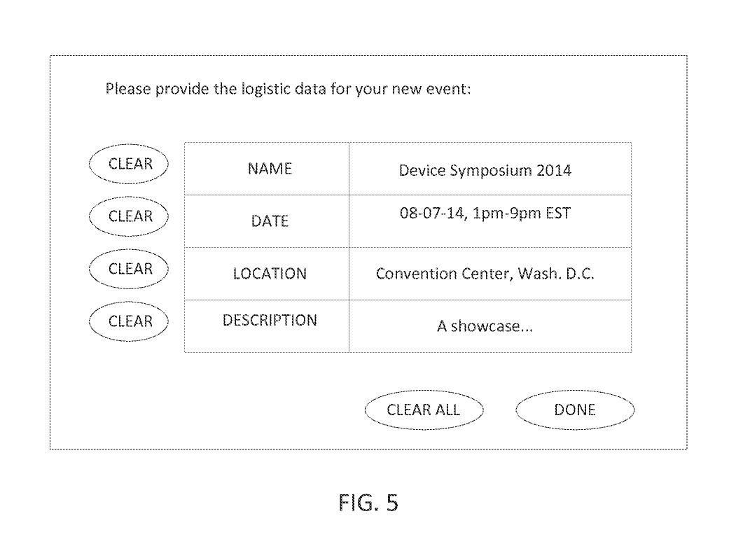

At 306, the event management computing system 102 may receive and store (e.g., in the storage device 212) event logistic data and a care provider invitee list provided by the manufacturer representative via the manufacturer computing system 104. In some embodiments, in response to the indication from the manufacturer computing system 104 that a new event entry is to be created, the event management computing system 102 may provide the illustrative display of FIG. 5 to a display device included in the manufacturer computing system 104. The display of FIG. 5 may include fillable fields for the manufacturer representative to provide logistic data for the new event. This logistic data may include, for example, a name for the new event, a date for the new event, a location for the new event, and a description for the new event. The event management computing system 102 may be configured to store the logistic data after entry. In some embodiments, the event management computing system 102 may require that new event entries be associated with events that are to take place within a predetermined window of the present date (e.g., within fourteen months of the present date).

Some events that may be tracked by the event management computing system 102 may be associated with a date that spans multiple days. For example, an event used to track consulting contracts may be associated with an entire year (or quarter, or other date span corresponding to the duration of the contracts). An example of this is illustrated in FIG. 4 for the event “Consulting Contracts 2014,” which is associated with a year-long date range (2014). In some embodiments, a year- or month-long date range (e.g., “2013” or “March 2013”) may be used by a manufacturer representative to represent an event that took place in the past, but whose exact date is not known or not relevant. Such ranges may allow a manufacturer's representative to quickly “catch up” on the logging of past events into the event management computing system 102 without needing to specify a precise date. Some events that may be tracked by the event management computing system 102 may not be associated with a singular location, but with multiple locations (e.g., when events at a conference are distributed across different venues) or no particular location (e.g., when the event is the distribution of an instructional DVD to care providers via postal mail). A location designator of “global” or “none” may be used in the latter case, or a designator that indicates the geographic scope may be used (e.g., “KY” if the instructional DVD is distributed only to care providers in Kentucky for that event).

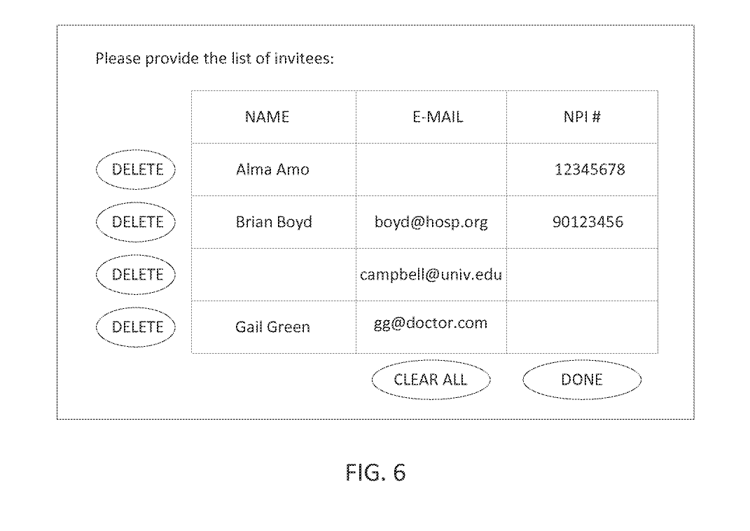

After receipt of the logistic data, the event management computing system 102 may provide the illustrative display of FIG. 6 to a display device included in the manufacturer computing system 104. The display of FIG. 6 may include fillable fields for the manufacturer representative to provide an invitee list for the new event. In some embodiments, the display of FIG. 6 may enable the manufacturer representative to provide one or more identifiers of a particular invitee. For example, the display of FIG. 6 may enable the manufacturer representative to provide a name of an invitee, an email address of the invitee, and a National Provider Identifier (NPI) of the invitee. If the manufacturer representative does not have access to one or more of these pieces of data for a particular invitee, the manufacturer representative may leave the particular fillable field blank.

For some events, the invitee list may include a single invitee. For example, when the event is a gift to a single care provider, or a consulting arrangement with a single care provider, the invitee list for such an event may only include the single care provider.

Returning to FIG. 3, at 308, in response to receipt of the invitee list from the manufacturer computing system 104, the event management computing system 102 may attempt to validate the invitee list. If an invitee in the invitee list cannot be validated, the event management computing system 102 may proceed to 310 and provide an alert of invalid invitee data to the manufacturer computing system 104.

In some embodiments, validating the invitee list at 308 may include determining whether each of the invitees is a care provider that has a care provider account in the event management computing system 102. In some embodiments, validating the invitee list may include alternative or additional operations.

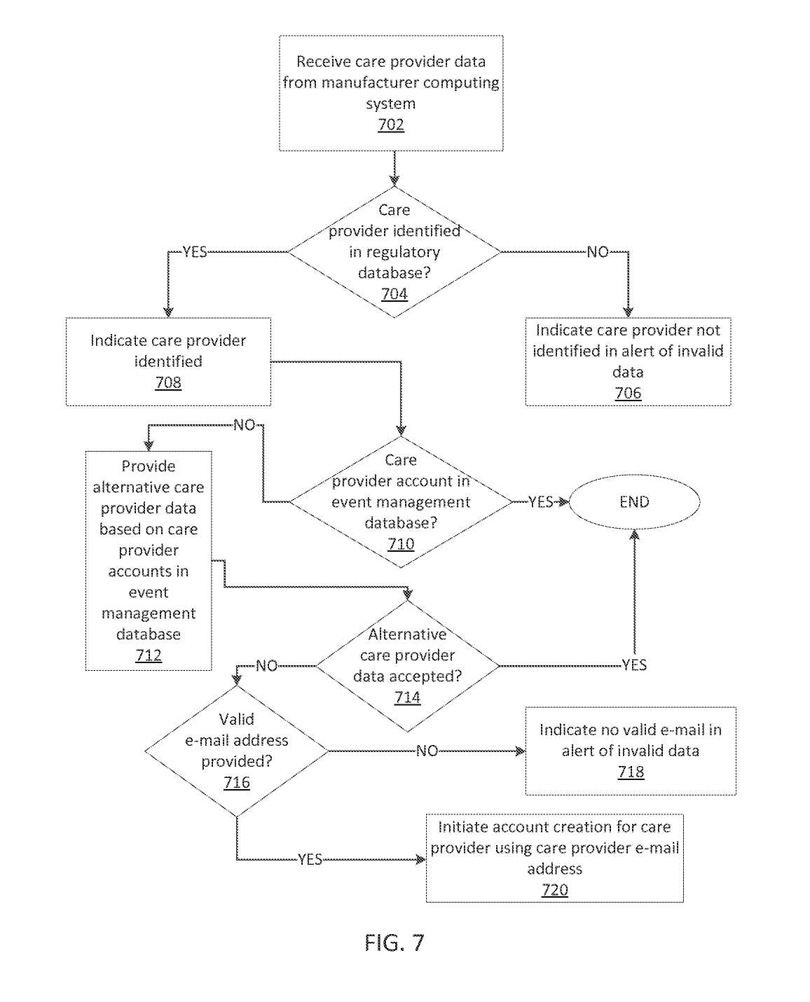

For example, FIG. 7 is a flow diagram of a method for validating an invitee, in accordance with various embodiments, that may be performed by the event management computing system 102 at the operations 308 and 310 of FIG. 3. The operations of FIG. 7 may be performed for each invitee on the invitee list (e.g., in parallel, in series, or in any suitable order).

The method of FIG. 7 may begin at 702, at which the event management computing system 102 may receive the care provider invitee data from the manufacturer computing system 104. At 704, the event management computing system 102 may access a regulatory database of care provider identification information (e.g., included in the regulator computing system 108) to determine whether each care provider is included in the regulatory database. In some embodiments, the care provider identification information used to check the regulatory database may include the care provider's name and state of practice, and/or the care provider's NPI. If the care provider cannot be located in the regulatory database, the event management computing system 102 may proceed to 706, and may provide an indication to the manufacturer computing system 104 that the care provider has not been identified (e.g., in the alert of 310 of FIG. 3).

If the care provider can be located in the regulatory database, event management computing system 102 may proceed to 708, and may provide an indicator to the manufacturer computing system 104 that the care provider has been identified in the regulatory database. In some embodiments, the operations of 708 may not be performed, and instead the event management computing system 102 may proceed to 710 and determine whether a care provider has an account in an event management database maintained by the event management computing system 102 (e.g., stored in the storage device 212).

If the event management computing system 102 determines that the care provider has an account in the event management database, the care provider may be validated and the method of FIG. 7 may end. If the event management computing system 102 determines that the care provider does not have an account in the event management database, the event management computing system 102 may proceed to 712 and provide alternative care provider data to the manufacturer computing system 104 based on care provider accounts that do exist in the event management database.

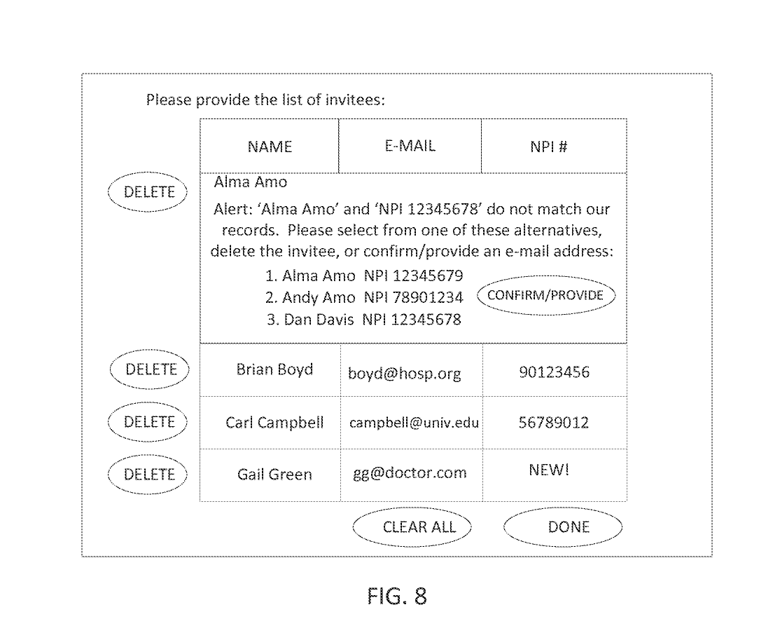

For example, FIG. 8 is an illustrative display that may be provided to a display device of the manufacturer computing system 104 by the event management computing system 102 when a care provider account does not exist (e.g., as part of 712 of FIG. 7), in accordance with various embodiments. In the display of FIG. 8, alternative care providers may be suggested, some or all of whose information matches the information provided by the manufacturer representative for the invalid invitee. The display FIG. 8 may give the manufacturer representative the option to select an alternative invitee, delete the invalid invitee, or confirm/provide an email address for the invitee that may be used by the event management computing system 102 to create an account for the invitee (as discussed below).

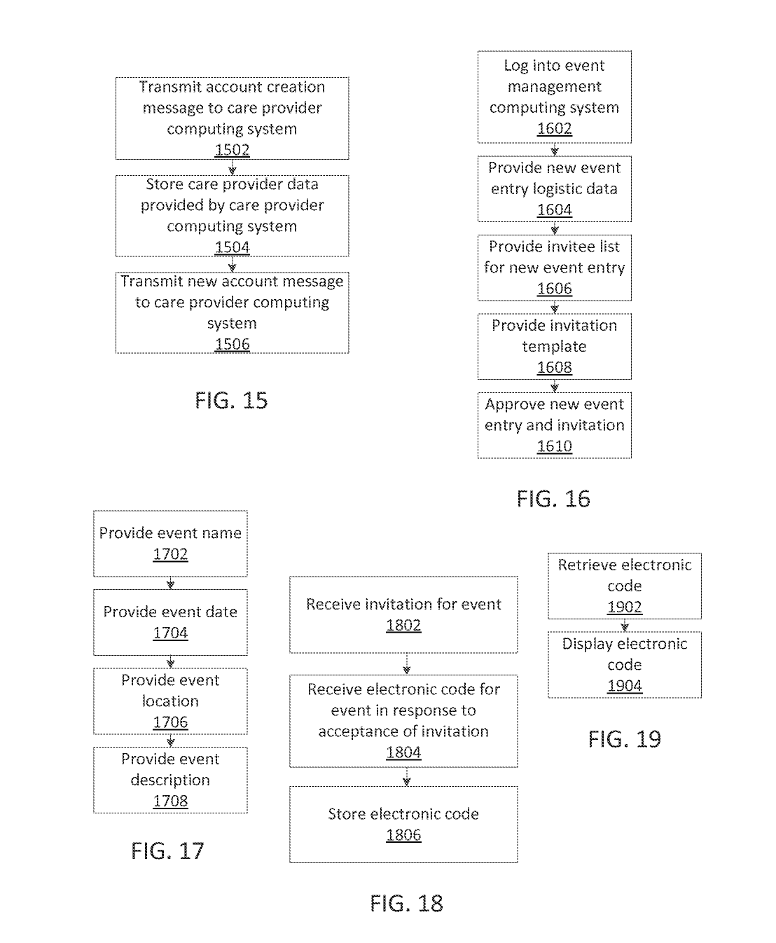

Returning to FIG. 7, at 714, event management computing system 102 may determine whether the manufacturer representative (via the manufacturer computing system 104) has accepted some of the alternative care provider data. If some of the alternative care provider data has been accepted, the method of FIG. 7 may end. If the alternative care provider data has not been accepted, the event management computing system 102 may proceed to 716, and determine whether a valid email address has been provided for the invitee. If not, the event management computing system 102 may provide an indication at 718 to the manufacturer computing system 104 that no valid email address has been provided (e.g., in the alert of 310 of FIG. 3), and the method of FIG. 7 may end. If the event management computing system 102 determines at 716 that a valid email address has been provided, the event management computing system 102 may initiate an account creation method at 720 to create an account for the care provider using the care provider email address provided by the manufacturer computing system 104 (e.g., as discussed below with reference to FIG. 15). The method of FIG. 7 may then end.

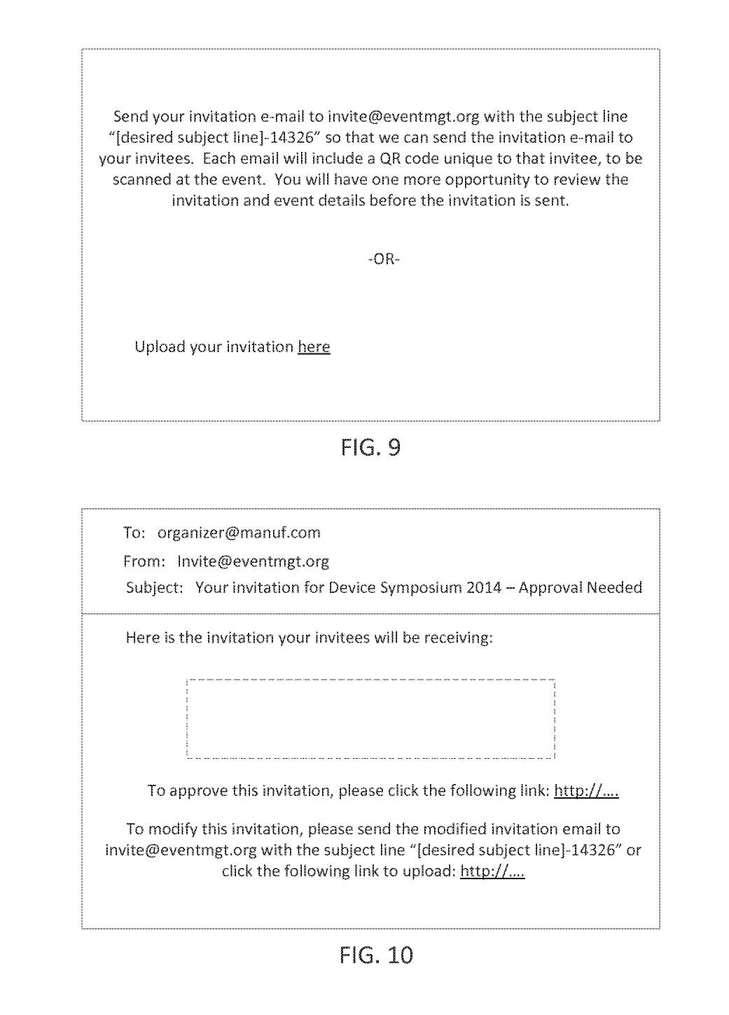

Returning to FIG. 3, once the invitee list is validated (which may include initiating an account creation process for care providers that do not have existing accounts with the event management computing system 102), the event management computing system 102 may proceed to 312 and receive and store an invitation template from the manufacturer computing system 104. The invitation template may form the basis on which an invitation for the event will be sent to the invitees. In some embodiments, a manufacturer representative using the manufacturer computing system 104 may be prompted by the event management computing system 102 to provide the invitation template. For example, FIG. 9 is an illustrative display that may be provided to a display device of the manufacturer computing system 104 by the event management computing system 102 to prompt the manufacturer computing system 104 to provide an invitation template, in accordance with various embodiments. In particular, the display of FIG. 9 describes a method by which the manufacturer representative can email an invitation template to the event management computing system 102, and also provides a selectable option for the manufacturer representative to upload an invitation template. An invitation template may be in any suitable form (e.g., a Portable Document Format (PDF) file, a MICROSOFT Word document with fields, an email file, etc.) and the technique used to upload the invitation template may be any conventional upload technique.

Returning to FIG. 3, at 314, the event management computing system 102 may provide a draft invitation to the manufacturer computing system 104 for review by the manufacturer representative. In some embodiments, when the invitation is to be transmitted to the invitees via email, the draft invitation may be transmitted to the manufacturer representative via email. FIG. 10 is an illustrative email that may be transmitted to the manufacturer computing system 104 by the event management computing system 102 to demonstrate the invitation that will be sent to the invitees of an event, in accordance with various embodiments. The dotted box in FIG. 10 indicates where the body of the invitation may be presented. The email of FIG. 10 also includes a link that may be selected by the manufacturer representative to approve the invitation, and a procedure by which the manufacturer representative can modify the invitation (e.g., by email or by following a link to upload).

Returning to FIG. 3, if the event management computing system 102 determines at 316 that approval of the invitation has been received, the event management computing system 102 may proceed to 318 and transmit invitations based on the invitation template to the invitees of the event. The method of FIG. 3 may then end. If the event management computing system 102 determines at 316 that approval of the invitation has not been received, the event management computing system 102 may return to 312, and may await a modification to the invitation template from the manufacturer computing system 104. In various embodiments, the manufacturer representative may return to any previous stage in the method of FIG. 3 to edit logistic data, invitee data, or invitation template data as desired.

For some events, the event management computing system 102 may not generate or send an invitation. For example, when the event management computing system 102 is being used by a manufacturer representative to track a gift already given to a care provider, or a consulting agreement already entered into, the manufacturer representative may skip or otherwise not perform operations related to the generation and sending of an invitation.

In some embodiments, the invitation may take the form of a gift offer. For example, when the event is the gifting of medical equipment (e.g., a stethoscope), the invitation may describe the medical equipment and ask the care provider if he or she wishes to receive the medical equipment. In some embodiments, the invitation may take the form of a consulting or other agreement. For example, when the event is a consulting arrangement, the invitation may include a description of the desired consulting services and any contractual language used to form a consulting agreement.

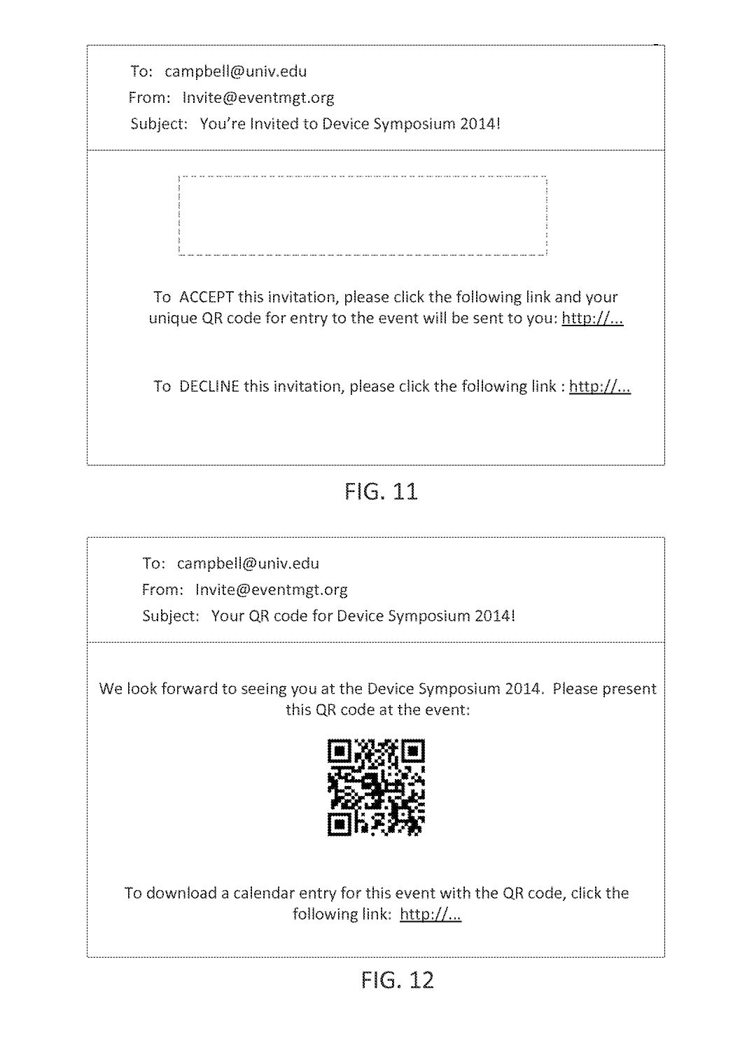

FIG. 11 is an illustrative invitation email that may be transmitted to the care provider computing system 106, associated with a care provider on an invitee list for an event, by the event management computing system 102, in accordance with various embodiments. The email of FIG. 11 includes the body of the invitation per the invitation template provided by the manufacturer computing system 104 (as represented by the dotted box in FIG. 11), and may include links that may be selected by the care provider to accept or decline the invitation. In some embodiments, the invitation may indicate that, upon acceptance, an electronic code (e.g., a QR code) may be transmitted to the care provider computing system 106 for entry to the event (e.g., as shown in FIG. 11).

FIG. 12 is an illustrative email, including an electronic code, that may be transmitted to the care provider computing system 106 by the event management computing system 102 in response to acceptance of an invitation to an event, in accordance with various embodiments. As shown in FIG. 12, the email may include a link to allow the care provider to download a calendar entry (including the electronic code) for the event for inclusion in the electronic calendar system of the care provider computing system 106. In some embodiments, electronic code included in an email or calendar entry from the event management computing system 102 may be automatically included in an electronic code storage location (e.g., in the storage device 212) managed by an app or other logic of the care provider computing system 106. The electronic code may be unique to the care provider so as to allow the electronic code to uniquely identify the care provider at the event. In some embodiments, the electronic code may be unique to the care provider and may not change between events so that the electronic code always identifies the care provider (unless the electronic code is misappropriated or otherwise tampered with, in which case a new electronic code may be issued). For example, in some embodiments, the electronic code (e.g., a QR code) may encode the care provider's NPI. In some embodiments, the electronic code may be unique to both the care provider and the event. For example, the electronic code (e.g., a QR code) may encode an identifier of the care provider (e.g., a name or NPI) and logistic data about the event (e.g., the event name, location, or any other suitable data). In some embodiments, the electronic code may be unique to both the care provider and the manufacturer.

In some embodiments in which the invitation is a gift offer, the care provider may receive an electronic code when he or she indicates acceptance of the gift. That electronic code may be provided to a manufacturer representative or delivery person upon receipt of the gift to confirm that the gift was provided to its intended recipient. In other embodiments in which the invitation is a gift offer, the care provider may not receive an electronic code when he or she indicates acceptance of the gift. In some embodiments in which the invitation is a consulting arrangement, the care provider may receive an electronic code when he or she indicates accord with the arrangement. That electronic code may be provided when the care provider arrives at a board meeting or other scheduled consulting meeting to confirm the care provider's presence at that meeting. In other embodiments in which the invitation is a consulting arrangement, the care provider may not receive an electronic code when he or she indicates accord with the arrangement.

As noted above, any of the data used to support the operations of the reporting management systems disclosed herein may be stored in any suitable data structure in any suitable devices. FIG. 13 depicts an illustrative data structure for storing event data, in accordance with various embodiments. Each event managed by the event management computing system 102, for example, may have a corresponding data structure (e.g., the data structure of FIG. 13) in which data associated with the event may be stored. The data structure of FIG. 13 may be stored in the storage device 212. The data structure of FIG. 13 may include a manufacturer identifier field (identifying the manufacturer sponsoring the event), a representative identifier field (identifying the manufacturer representative that created or is otherwise responsible for the event), an event name field (identifying a name of the event), an event date field (identifying a date and time for the event), an event description field (identifying a description of the event), an event location field (identifying a location of the event), an invitee list and status field (which may point to another data structure storing the invitee list and related data, as discussed below with reference to FIG. 14), and an invitation field (identifying a file or storage location of a file containing the invitation template).

FIG. 14 depicts an illustrative data structure for storing invitee data, in accordance with various embodiments. In some embodiments, the data structure of FIG. 14 may be associated with a particular event, and may provide the invitee list and related information for that particular event. The data structure of FIG. 14 may be stored in the storage device 212. As noted above with reference to FIG. 13, a data structure storing event data may point to the data structure of FIG. 14 for invitee-related data. The data structure of FIG. 14 may include an invitee field (identifying a name of an invitee), an email field (identifying an email address of the invitee), and NPI field (identifying an NPI of the invitee), an RSVP field (identifying whether the invitee has responded to the invitation, and if so, what the response was), an attendance field (identifying whether the invitee attended the event), an amount spent field (identifying the amount spent on the invitee at the event), a state field (identifying the state in which the invitee practices), and an amount spent confirmation field (identifying whether the invitee has confirmed the amount spent on her during the event). Some of the fields in the data structure of FIG. 14 may be populated by the manufacturer computing system 104 prior to the event, some of the fields in the data structure of FIG. 14 may be populated by the manufacturer computing system 104 during or after the event, and some of the fields in the data structure of FIG. 14 may be populated by the event management computing system 102 (e.g., before, after, or during the event), as discussed herein.

As noted above, the event management computing system 102 may be configured to create care provider accounts for care providers that may be invited to events by the manufacturer computing system 104. These care provider accounts may include a name of the care provider, an email address for the care provider, a telephone number for the care provider (e.g., a cell phone number and/or an office number), contact preferences for the care provider (e.g., whether the care provider wishes to receive text messages or emails), a location or locations in which the care provider practices, or any other information suitable for storing any care provider account for use with the reporting management operations disclosed herein. FIG. 15 is a flow diagram of a method for creating a care provider account, in accordance with various embodiments. For illustrative purposes, the method of FIG. 3 may be discussed as performed by the event management computing system 102.

At 1502, the event management computing system 102 may transmit an account creation message to the care provider computing system 106. In some embodiments, the account creation message may be an email, inviting the care provider to access a website hosted by the event management computing system 102 and to create an account in accordance with known account creation techniques. For example, in some embodiments, the account creation message may include a temporary user name and randomly generated password for the care provider that the care provider may use to initially log in to the event management computing system 102 (and then may be changed). In some embodiments, the operations of 1502 may not be performed, and instead, the care provider may independently visit a website of the event management computing system 102 to create an account.

At 1504, the event management computing system 102 may store the data provided by the care provider during the account creation process (e.g., data provided through a Web-based interface).

At 1506, the event management computing system 102 may transmit a new account message (e.g., an email message) to the care provider computing system 106 to confirm the creation of the care provider's account. The method of FIG. 15 may then end.

FIG. 16 is a flow diagram of a method for creating an invitation for a new event, in accordance with various embodiments. For illustrative purposes, the method of FIG. 16 may be discussed as performed by the manufacturer computing system 104. The operations of the method of FIG. 16 may be complementary to the operations of the method of FIG. 3.

At 1602, a manufacturer representative may log into the event management computing system 102 via the manufacturer computing system 104.

At 1604, the manufacturer representative may provide new event entry logistics data to the event management computing system 102 via the manufacturer computing system 104.

At 1606, the manufacturer representative may provide an invitee list for the new event entry to the event management computing system 102 via the manufacturer computing system 104.

At 1608, the manufacturer representative may provide an invitation template for the new event entry to the event management computing system 102 via the manufacturer computing system 104.

At 1610, the manufacturer representative may provide her approval of the new event entry and invitation to the event management computing system 102 via the manufacturer computing system 104. The method of FIG. 16 may then end.

FIG. 17 is a flow diagram of a method for providing new event logistic data, in accordance with various embodiments. The method of FIG. 17 may be performed as part of the operations of 1604 discussed above with reference to the method of FIG. 16. For illustrative purposes, the method of FIG. 17 may be discussed as performed by the manufacturer computing system 104. The data provided by the manufacturer computing system 104 during the method of FIG. 17 may be stored by the event management computing system 102 in the data structure of FIG. 13, for example.

At 1702, a manufacturer representative may provide an event name to the event management computing system 102 via the manufacturer computing system 104.

At 1704, a manufacturer representative may provide an event date to the event management computing system 102 via the manufacturer computing system 104.

At 1706, a manufacturer representative may provide an event location to the event management computing system 102 via the manufacturer computing system 104.

At 1708, a manufacturer representative may provide an event description to the event management computing system 102 via the manufacturer computing system 104. The method of FIG. 17 may then end.

FIG. 18 is a flow diagram of a method for receiving and storing an electronic code, in accordance with various embodiments. For illustrative purposes, the method of FIG. 18 may be discussed as performed by the care provider computing system 106.

At 1802, the care provider computing system 106 may receive an invitation for an event from the event management computing system 102. The invitation and event details may have been provided by the manufacturer computing system 104 (e.g., as discussed above with reference to FIG. 3). An illustrative invitation is shown in FIG. 11.

At 1804, the care provider computing system 106 may receive an electronic code for the event in response to acceptance by the care provider computing system 106 of the invitation. In some embodiments, the electronic code may be provided by the event management computing system 102. Electronic code may be provided to the care provider computing system 106 in an email or in any other suitable format. An illustrative email including an electronic code is shown in FIG. 12.

At 1806, the care provider computing system 106 may store the received electronic code (e.g., in the storage device 212). The electronic code may be retrieved and displayed when the care provider attends the event associated with the invitation (as discussed below with reference to FIG. 19).

FIG. 19 is a flow diagram of a method for displaying an electronic code, in accordance with various embodiments. For illustrative purposes, the method of FIG. 19 may be discussed as performed by the care provider computing system 106.

At 1902, the care provider computing system 106 may retrieve a previously stored electronic code (e.g., from the storage device 212) provided to the care provider computing system 106 in response to acceptance by the care provider computing system 106 of an invitation to an event. In some embodiments, the care provider computing system 106 may automatically retrieve the previously stored electronic code at the time that the event is to take place (e.g., via a calendar or specialized app). In some embodiments, the care provider computing system 106 may be used to access a care provider's email account, and electronic code may be retrieved from the care provider's previously received email messages.

At 1904, the care provider computing system 106 may display the electronic code for identification by the manufacturer computing system 104 at the event. The manufacturer computing system 104 may store and provide the electronic code to the event management computing system 102 to confirm the care provider's attendance at the event.

In other embodiments, the care provider computing system may provide the electronic code to the manufacturer computing system without visually displaying the electronic code. For example, the care provider computing system may transmit the electronic code via a wireless communication protocol, such as via an NFC communication or RFID communication.

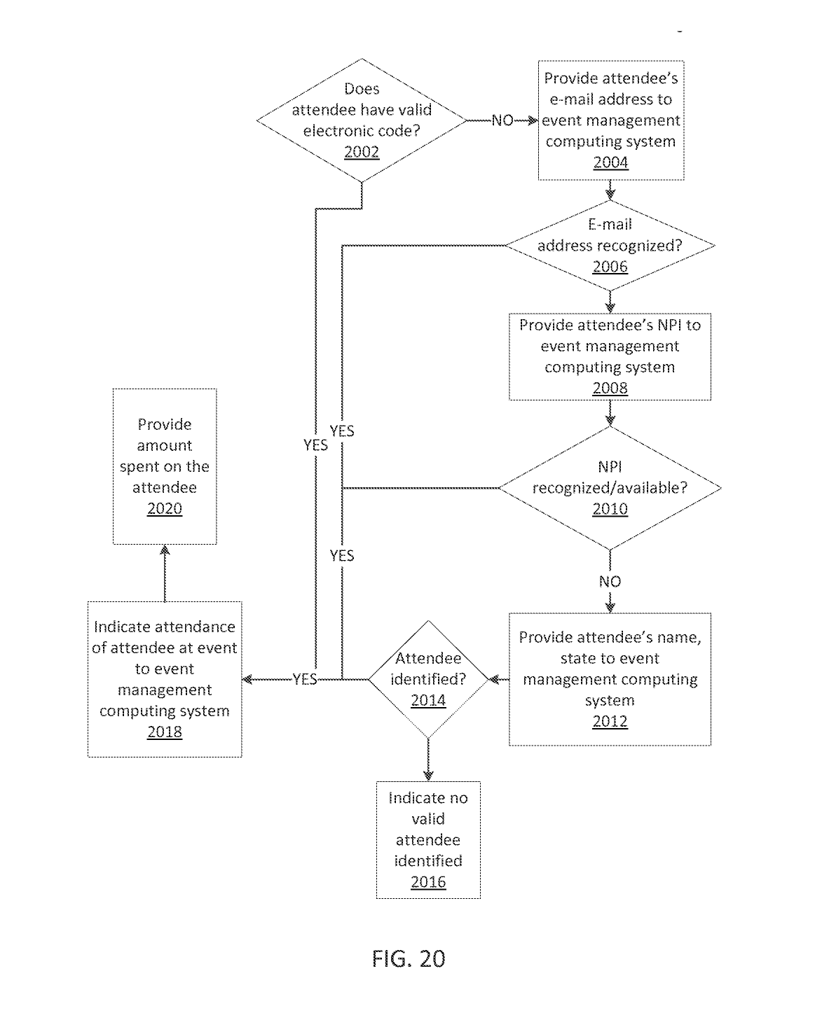

FIG. 20 is a flow diagram of a method for validating and storing attendee data, in accordance with various embodiments. The operations discussed below with reference to FIG. 20 may take place during and after an event for which the event management computing system 102 transmitted an electronic code to the care provider computing system 106 associated with an invited care provider. For illustrative purposes, the method of FIG. 20 may be discussed as performed by the manufacturer computing system 104. The method of FIG. 20 may be performed for each attendee at an event sponsored by the manufacturer associated with the manufacturer computing system 104.

At 2002, the manufacturer computing system 104 may determine whether an attendee at the event (e.g., at a registration desk) has a valid electronic code for the event. A valid electronic code is electronic code provided to a computing device included in the care provider computing system 106 associated with the attendee, and provided by the event management computing system 102 in response to receipt of an invitee list from the manufacturer computing system 104. To perform the determination of 2002, a manufacturer representative may use an electronic code reader (e.g., an image capture device, a QR code reader, a bar code reader, etc.) included in the manufacturer computing system 104 to scan an electronic code displayed by a computing device of the care provider computing system 106 (if available), and the data generated by the electronic code reader may be decoded by the manufacturer computing system 104 to determine whether the attendee is a valid attendee or may be provided to the event management computing system 102 to determine whether the attendee is a valid attendee. If the manufacturer computing system 104 determines at 2002 that the attendee has a valid electronic code, the manufacturer computing system 104 may indicate the attendance of the attendee at the event to the event management computing system 102 (e.g., via a communication network). This indication of attendance may occur contemporaneously, or after the event is finished.

If the manufacturer computing system 104 determines at 2002 that the attendee does not have a valid electronic code, the manufacturer computing system 104 may proceed to 2004 and provide the attendee's email address to the event management computing system 102. The email address of the attendee may be requested from the attendee by the manufacturer representative at the event, and may be input to the manufacturer computing system 104 for provision to the event management computing system 102. In response to receiving the email address, the event management computing system 102 may determine whether the attendee has an account with the event management computing system 102 (e.g., in accordance with 710 of the method of FIG. 7 discussed above).

If the manufacturer computing system 104 determines at 2006 (e.g., based on an indicator provided by the event management computing system 102) that the email address of the attendee is recognized, the manufacturer computing system 104 may proceed to 2018 and indicate the attendance of the attendee at the event to the event management computing system 102 (e.g., via a communication network).

If the manufacturer computing system 104 determines at 2006 that the email address of the attendee is not recognized by the event management computing system 102 (e.g., no account associated with that email address exists), the manufacturer computing system 104 may proceed to 2008 and provide the attendee's NPI to the event management computing system 102. The NPI of the attendee may be requested from the attendee by the manufacturer representative at the event, and may be input to the manufacturer computing system 104 for provision to the event management computing system 102. In response to receiving the NPI, the event management computing system 102 may determine whether the attendee can be identified in a regulatory database (e.g., in accordance with 704 of the method of FIG. 7 discussed above).

If the manufacturer computing system 104 determines at 2010 (e.g., based on an indicator provided by the event management computing system 102) that the NPI of the attendee is recognized, the manufacturer computing system 104 may proceed to 2018 and indicate the attendance of the attendee at the event to the event management computing system 102. In some embodiments, the event management computing system 102 may use the email address of the attendee to initiate an account creation process for the attendee (e.g., as discussed above with reference to FIG. 15).

If the manufacturer computing system 104 determines at 2010 that the NPI of the attendee is not recognized by the event management computing system 102, the manufacturer computing system 104 may proceed to 2012 and provide the attendee's name and state of practice to the event management computing system 102. The name and state of practice of the attendee may be requested from the attendee by the manufacturer representative at the event, and may be input to the manufacturer computing system 104 for provision to the event management computing system 102. In response to receiving the name and state of practice, the event management computing system 102 may determine whether the attendee can be identified in a regulatory database (e.g., in accordance with 704 of the method of FIG. 7 discussed above).

If the manufacturer computing system 104 determines at 2014 (e.g., based on an indicator provided by the event management computing system 102) that the name and state of the attendee is recognized, the manufacturer computing system 104 may proceed to 2018 and indicate the attendance of the attendee at the event to the event management computing system 102. In some embodiments, the event management computing system 102 may use the email address of the attendee to initiate an account creation process for the attendee (e.g., as discussed above with reference to FIG. 15).

If the manufacturer computing system 104 determines at 2014 (e.g., based on an indicator provided by the event management computing system 102) that the attendee still cannot be identified, the manufacturer computing system 104 may proceed to 2016 and may indicate (e.g., via a display device of the manufacturer computing system 104) that no valid attendee has been identified. The manufacturer representative at the event may then determine whether to turn the attendee away or allow the attendee admission to the event. The method of FIG. 20 may then end.

Upon indicating the attendance of an attendee at the event at 2018, the manufacturer computing system 104 may proceed to 2020 and provide, to the event management computing system 102, an amount spent on the attendee. The operation of 2020 may be performed after the event, in some embodiments. The items included in the amount spent may be determined by legal regulations, and may include any appropriate transfers of value required by the regulations. In some embodiments, the amount spent on an attendee may include data descriptive of the marketed name of any drugs, biologicals, devices, and medical supplies associated with the amount spent, and this data may be provided to the regulator computing system 108 (and stored by the event management computing system 102) along with any provision of amount spent data.

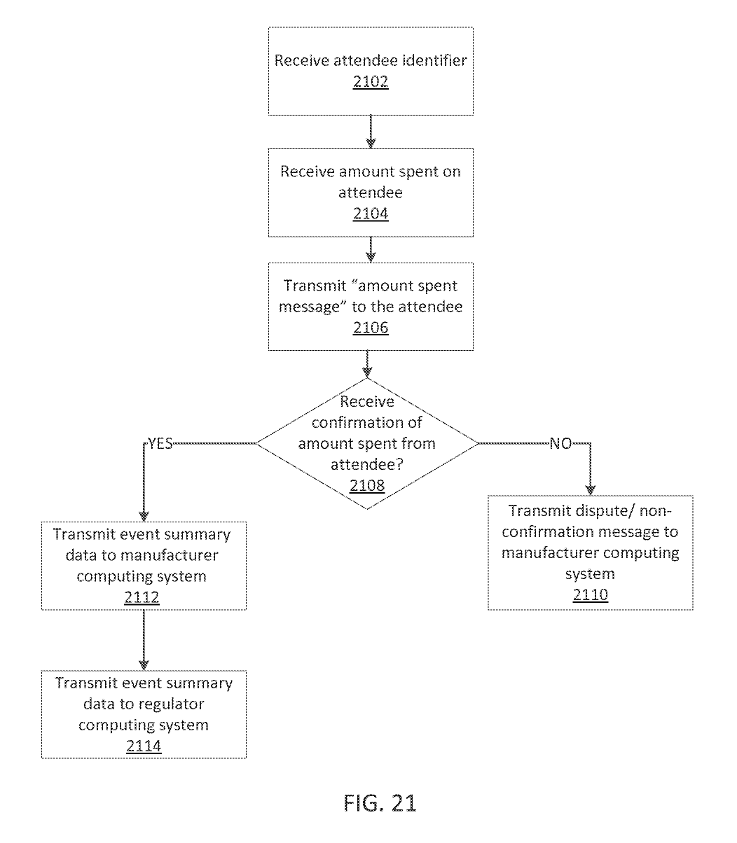

FIG. 21 is a flow diagram of a method for receiving and processing attendee data, in accordance with various embodiments. The operations discussed below with reference to FIG. 21 may take place during and after an event for which the event management computing system 102 transmitted an electronic code to the care provider computing system 106 associated with an invited care provider. For illustrative purposes, the method of FIG. 21 may be discussed as performed by the event management computing system 102. Various operations of the method of FIG. 21 may be performed for each attendee at an event sponsored by the manufacturer associated with the manufacturer computing system 104, and various operations of the method of FIG. 21 may be “batch” and performed simultaneously or substantially simultaneously for all of the attendees at a particular event. The operations of the method of FIG. 21 may be performed for events that include multiple attendees (e.g., an evening reception) as well as events that include a single attendee (e.g., a gift to a single care provider or a consulting agreement with a single care provider). In some embodiments, the operations of the method of FIG. 21 may be performed regardless of whether an electronic code was provided to the care provider as part of the event management process; the operations of the method of FIG. 21 may still be used to confirm the event.

At 2102, the event management computing system 102 may receive identifiers of the attendees at an event from the manufacturer computing system 104. The identifiers may include a name, an email address, an NPI, an account number for the attendee in the event management database of the event management computing system 102, or any other suitable identifier.

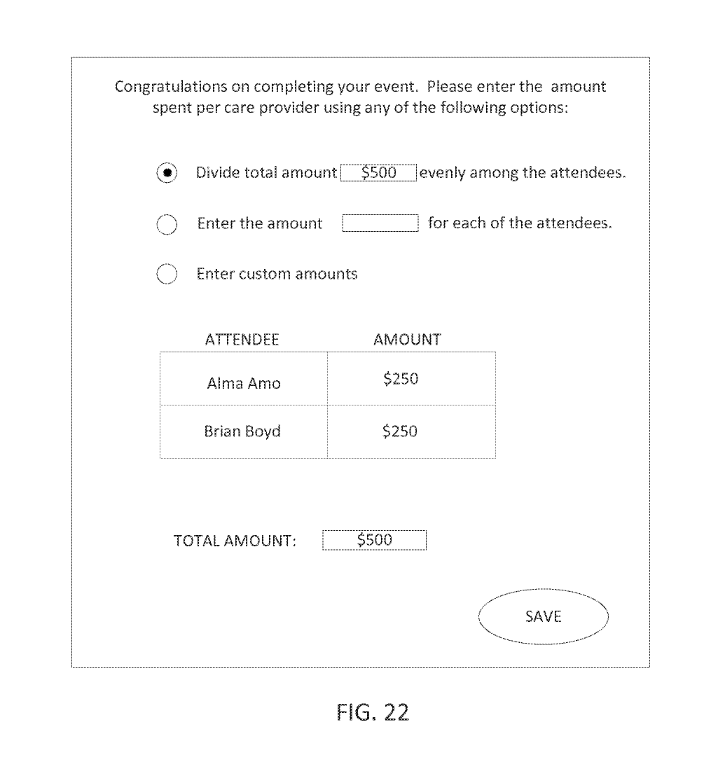

At 2104, the event management computing system 102 may receive, from the manufacturer computing system 104, an amount spent on each attendee at the event. In some embodiments, the manufacturer computing system 104 may provide the amount spent in response to a user interface provided by the event management computing system 102. For example, FIG. 22 is an illustrative display that may be provided to the manufacturer computing system 104 by the event management computing system 102 (e.g., via a Web-based interface) to prompt the manufacturer computing system 104 to input amount spent data, in accordance with various embodiments. Various interfaces may be used in any suitable combination to receive amount spent data from the manufacturer computing system 104. For example, in some embodiments, the manufacturer representative may have the option to provide total amount spent at the event and indicate to the event management computing system 102 that the amount is to be divided evenly among the attendees. In some embodiments, the manufacturer representative may have the option to enter a predetermined amount to be attributed to each attendee. In some embodiments, the manufacturer representative may have the option to enter a custom amount spent for each attendee. The display of FIG. 22 illustrates that the manufacturer representative may choose among these options for providing amount spent data.

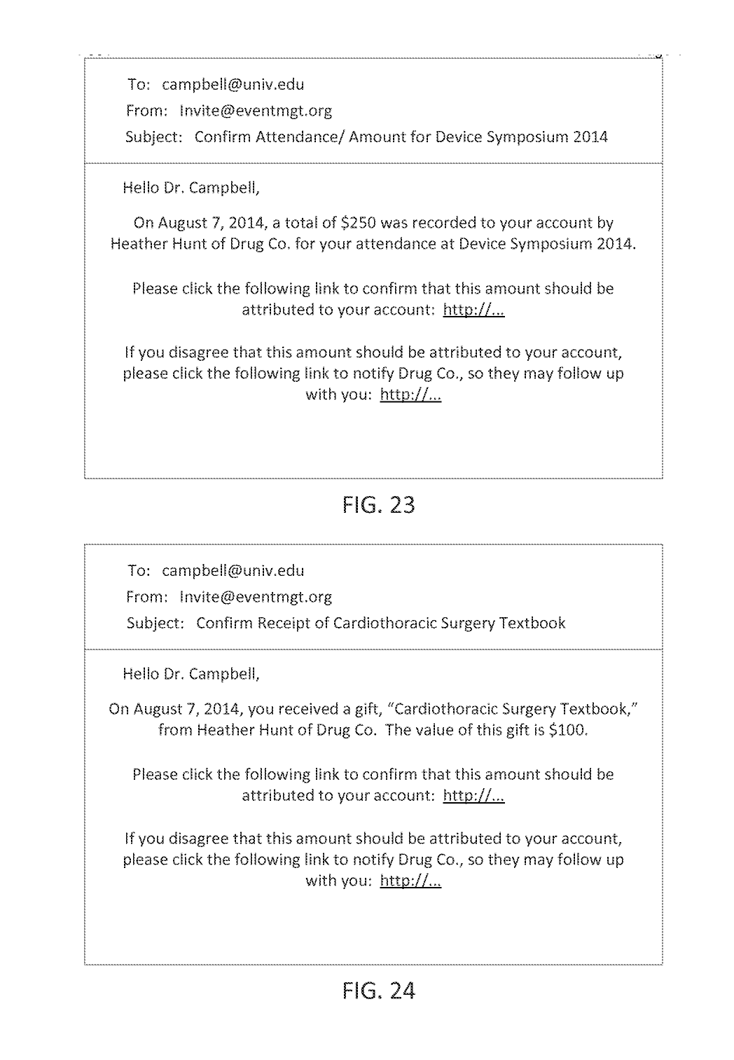

Returning to FIG. 21, at 2106, the event management computing system 102 may transmit an amount spent message to the care provider computing system 106 associated with each attendee at the event. The amount spent message may identify the event (e.g., by name) and may also identify the amount spent on the attendee as provided by the manufacturer computing system 104. For example, FIG. 23 is an illustrative email that may be provided to the care provider computing system 106 by the event management computing system 102 to prompt the care provider computing system 106 to confirm or reject an amount spent on the care provider during the care provider's attendance at a symposium, in accordance with various embodiments. In another example, FIG. 24 is an illustrative email that may be provided to the care provider computing system 106 by the event management computing system 102 to prompt the care provider computing system 106 to confirm or reject an amount spent on a gift for the care provider, in accordance with various embodiments. A similar e-mail may be used to prompt the care provider computing system 106 to confirm or reject an amount spent as part of a consulting arrangement with the care provider (e.g., a consulting fee, per diems, and travel expenses). For example, a care provider that serves as a consultant or advisory board member to a manufacturer may incur costs that need to be reimbursed and fees paid, and the e-mail may indicate “Between Oct. 11, 2014 and Oct. 15, 2014, you provided consultation and/or speaker services with expenses and compensation totaling $20,000.” An appropriate message may be generated for each tracked event to allow the care provider to timely review the amount spent for different events. In some embodiments, an amount spent message may refer to multiple events that occurred within a predetermined window (e.g., one e-mail per week, referencing all of the events that occurred in the past week). As shown in FIGS. 23 and 24, an amount spent message may include a link to allow a care provider associated with the care provider computing system 106 to confirm the amount spent, and a link to allow the care provider associated with the care provider computing system 106 to dispute the amount spent.

Returning to FIG. 21, at 2108, the event management computing system 102 may determine whether it has received confirmation of the amount spent from each attendee. If the event management computing system 102 determines at 2108 that it has not received confirmation of the amount spent, event management computing system 102 may proceed to 2110 transmit a dispute/non-confirmation message to the manufacturer computing system 104. In response, the manufacturer computing system 104 may initiate a dispute resolution process with the attendee, or may follow up with the attendee to seek confirmation of the amount spent. In some embodiments, the event management computing system 102 may send follow-up amount spent messages to the attendee at predetermined intervals if the attendee fails to respond to the initial amount spent message.

If the event management computing system 102 determines at 2108 that the confirmation of the amount spent has been received from each attendee, the event management computing system 102 may proceed to 2112, and may transmit event summary data to the manufacturer computing system 104. The event summary data may include a list of invitees to the event, a list of attendees at the event, indicators of the various amounts spent on each attendee, and an indicator of when data about the event will be (or was) transmitted to the regulator computing system 108. The event summary data may be included in a message that requests that the manufacturer computing system 104 provide final confirmation of the event summary data before any data regarding the event is transmitted to the regulator computing system 108.

In some embodiments, after the event management computing system 102 has received confirmation from an attendee of the amount spent on that attendee at a particular event, no individual (e.g., manufacturer representative or the attendee herself) may be readily able to edit the attendee's presence and amount spent in the event summary data. This data may thus be considered “locked” against future editing, to prevent later falsification of event data (e.g., by the manufacturer or the attendee). In some embodiments, the event management computing system 102 may provide an adjudication process by which a manufacturer and an attendee may correct an error in the event data, and thereby effect a correction even after the attendee has confirmed the amount spent.

At 2114, the event management computing system 102 may transmit event summary data to the regulator computing system 108. The event summary data transmitted to the regulator computing system 108 may be different from the event summary data transmitted to the manufacturer computing system 104 at 2112, and may include event data relevant to compliance with the legal regulations supported by the regulator computing system 108. In some embodiments, the event summary data transmitted to the regulator computing system 108 may be provided in a format readily readable and importable into a database maintained by the regulator computing system 108 (e.g., in a particular file format with particular predetermined fields). The process of FIG. 21 may then end.

In some embodiments, once a care provider has an account with the event management computing system 102, all messages transmitted to the care provider computing system 106 associated with that care provider may include the care provider's electronic code (e.g., when the electronic code does not change between events). In some embodiments, the event management computing system 102 may provide an interface to the care provider computing system 106 (e.g., a web-based interface) through which the care provider computing system 106 can access information about events to which the associated care provider has been invited, events attended, amounts spent on the care provider at each event, and the total amounts spent on the care provider over various periods of interest. The care provider may also use this interface to update her contact information and other account information with the event management computing system 102.

In some embodiments, a care provider may indicate to the event management computing system 102 or the manufacturer computing system 104 (e.g., via the care provider computing system 106) that the care provider does not wish the event management computing system 102 and/or the manufacturer computing system 104 to store her personal, not publicly available data (such as e-mail address and phone number). This indication may be provided during or after the care provider sets up her account with the event management computing system 102, or during interactions between the care provider and the manufacturer. In some embodiments, publicly available data (such as the care provider's name, state and ZIP code) may be stored independent of the storage of other information about the care provider.

In some embodiments, certain personal information about a care provider may be stored by the event management computing system 102, but may not be visible to the manufacturer computing system 104 (even if the manufacturer computing system 104 is able to view other information about the care provider). For example, the event management computing system 102 may store a care provider's name, state, ZIP code, NPI, and e-mail address, but may not make the care provider's e-mail address visible to the manufacturer computing system 104. When a manufacturer representative accesses the event management computing system 102 (e.g., via the manufacturer computing system 104) to invite the care provider to an event, the manufacturer representative may identify the care provider by name, state, ZIP code, or NPI, and the event management computing system 102 may send the invitation to the care provider's e-mail address without revealing the care provider's e-mail address to the manufacturer representative. In some embodiments, if an e-mail invitation or other communication fails to be delivered to a care provider (e.g., because the e-mail address of record is no longer valid), the event management computing system 102 may notify the manufacturer computing system 104 of the failure (e.g., so that the manufacturer can attempt to contact the care provider in another way). This notification may be performed with or without revealing the e-mail address or other personal information of the care provider.

What is claimed is:

1. One or more non-transitory computer-readable media, having instructions, stored thereon, that when executed cause an event management computing system to:
receive, from a manufacturer computing system, event data, wherein the event data specifies an event and one or more care providers associated with the event;
in response to receipt of the event data from the manufacturer computing system, provide, over a first communications interface to a care provider computing system associated with a first care provider of the one or more care providers, an electronic code that is to be provided by the care provider computing system to the manufacturer computing system to demonstrate attendance of the first care provider at the event; and
receive, from the manufacturer computing system over a second communications interface based on receipt of the electronic code by the manufacturer computing system, an amount spent on the first care provider for the event.

2. The one or more media of claim 1, wherein the instructions, when executed, further cause the event management computing system to:
send an amount spent message to the care provider computing system, wherein the amount spent message indicates the amount spent received by the event management computing system; and
receive, from the computing system, a confirmation or rejection of the amount spent indicated in the amount spent message.

3. The one or more media of claim 2, wherein the instructions, when executed, further cause the event management computing system to:
send, to a regulator computing system over a third communications interface responsive to receipt of the confirmation, an identifier of the first care provider and an indicator of the amount spent.

4. The one or more media of claim 2, wherein the instructions, when executed, further cause the event management computing system to:
send, to the manufacturer computing system responsive to receipt of the rejection, a dispute message to indicate that the amount spent was rejected.

5. The one or more media of claim 1, wherein the instructions, when executed, further cause the event management computing system to:
provide an input interface to the manufacturer computing system to prompt a user of the manufacturer computing system to provide the amount spent to the event management computing system.

6. The one or more media of claim 5, wherein the input interface provides the user of the manufacturer computing system an option to divide a total cost of the event evenly over the one or more care providers to determine the amount spent or to provide individual amounts spent for respective care providers of the one or more care providers.

7. The one or more media of claim 1, wherein the electronic code is a Quick Response (QR) code, a radio frequency identification (RFID) code, a bar code, or a near-field communication (NFC) code.

8. The one or more media of claim 1, wherein the event is a conference, a social gathering, a consulting arrangement, a speaking engagement, or a gift.

9. The one or more media of claim 1, wherein the electronic code encodes an identifier of the first care provider.

10. The one or more media of claim 9, wherein the electronic code further encodes logistic data about the event.

11. One or more non-transitory computer-readable media, having instructions, stored thereon, that when executed cause a manufacturer computing system to:
provide, over a communications network to an event management computing system, event data, wherein the event data specifies an event and one or more care providers associated with the event, and wherein the event management computing system is to provide care provider computing systems associated with respective care providers of the one or more care providers with respective electronic codes based on the event data, the electronic codes including a first electronic code associated with a first care provider;
receive the first electronic code from a first care provider computing system associated with the first care provider to demonstrate attendance of the first care provider at the event; and
provide, over the communications network to the event management computing system and based on receipt of the first electronic code, an amount spent on the first care provider for the event.

12. The one or more media of claim 11, wherein the manufacturer computing system is to provide the amount spent to the event management computing system via an input interface, wherein the input interface provides a user of the manufacturer computing system an option to divide a total cost of the event evenly over the one or more care providers to determine the amount spent or to provide individual amounts spent for respective care providers of the one or more care providers.

13. The one or more media of claim 11, wherein the instructions, when executed, further cause the manufacturer computing system to provide an indication of attendance to the event management computing system responsive to receipt of the first electronic code, wherein the indication of attendance is to indicate attendance of the first care provider at the event.

14. The one or more media of claim 11, wherein the electronic code is a Quick Response (QR) code, a radio frequency identification (RFID) code, a bar code, or a near-field communication (NFC) code.

15. The one or more media of claim 14, wherein the instructions, when executed, further cause the manufacturer computing system to:
authenticate a second care provider based on an email address or National Provider Identifier (NPI) associated with the second care provider; and
provide, over the communications network to the event management computing system and based on the authentication, an amount spent on the second care provider for the event.

16. The one or more media of claim 11, wherein the event is a conference, a social gathering, a consulting arrangement, a speaking engagement, or a gift.

17. A reporting management system comprising:
an event management computing system including:
a first communications interface with a manufacturer computing system;
a second communications interface with a care provider computing system;
a third communications interface with a regulator computing system; and
operations logic coupled to the first, second, and third communications interfaces, the operations logic to:
receive, from the manufacturer computing system via the first communications interface, event data, wherein the event data specifies an event and one or more care providers associated with the event;
in response to receipt of the event data from the manufacturer computing system, provide, via the second communications interface to a care provider computing system associated with a first care provider of the one or more care providers, an electronic code that is to be provided by the care provider computing system to the manufacturer computing system to demonstrate attendance of the first care provider at the event;
receive, from the manufacturer computing system via the first communications interface based on receipt of the electronic code by the manufacturer computing system, an amount spent on the first care provider for the event; and
send, to the regulator computing system via the third communications interface responsive to receipt of the confirmation, an identifier of the first care provider and an indicator of the amount spent.

18. The system of claim 17, wherein the operations logic is further to:
send an amount spent message to the care provider computing system via the second communications interface, wherein the amount spent message indicates the amount spent received by the event management computing system and includes a prompt for the first care provider to confirm or reject the amount spent; and
receive, from the computing system, a confirmation of the amount spent indicated in the amount spent message;
wherein the identifier of the first care provider and the indicator of the amount spent is sent to the regulator computing system responsive to receipt of the confirmation by the event management computing system.

19. The system of claim 17, wherein the instructions, when executed, further cause the event management computing system to:
provide an input interface to the manufacturer computing system to prompt a user of the manufacturer computing system to provide the amount spent to the event management computing system.

20. The system of claim 19, wherein the input interface provides the user of the manufacturer computing system an option to divide a total cost of the event evenly over the one or more care providers to determine the amount spent or to provide individual amounts spent for respective care providers of the one or more care providers.

21. The system of claim 17, wherein the electronic code is a Quick Response (QR) code, a radio frequency identification (RFID) code, a bar code, or a near-field communication (NFC) code.

22. The system of claim 17, wherein the event is a conference, a social gathering, a consulting arrangement, a speaking engagement, or a gift.

23. The system of claim 17, further comprising the manufacturer computing system.
